(19) United States
(12) Patent Application Publication
(10) Pub. No.: US 2012/0054486 A1
(43) Pub. Date: Mar. 1, 2012

(54) Securing A Virtual Environment And Virtual Machines

(75) Inventors: Giridhar Vishwanath Lakkavalli, Bangalore (IN); Raghuveer Krishna, Bangalore (IN); Kiran Kumar Byrapura Rajanna, Bangalore (IN)

(73) Assignee: MindTree Limited

(21) Appl. No.: 12/902,152

(22) Filed: Oct. 12, 2010

(30) Foreign Application Priority Data
Aug. 31, 2010 (IN) 2531/CHE/2010

(51) Int. Cl. H04L 29/06

(52) U.S. Cl. 713/156; 713/155

(57) ABSTRACT

A computer implemented method and system for securing a virtual environment and virtual machines in the virtual environment is provided. A credential authority server is provided for managing environment credentials of the virtual environment. A virtual machine shim is associated with each of the virtual machines, and one or more hypervisor shims are associated with one or more hypervisors. The credential authority server provides, on request, environment credentials to each of the virtual machines and the hypervisors on authorization of each of the virtual machines and the hypervisors. Each virtual machine shim associated with each of the virtual machines communicates the provided environment credentials to the hypervisor shims for validation. The hypervisors associated with the hypervisor shims validate each of the virtual machines associated with each virtual machine shim based on the communicated environment credentials to allow instantiation of each of the virtual machines in the virtual environment.

### CROSS REFERENCE TO RELATED APPLICATIONS

This application claims the benefit of non-provisional patent application number 2531/CHE/2010 titled “Securing A Virtual Environment And Virtual Machines”, filed on Aug. 31, 2010 in the Indian Patent Office.

The specification of the above referenced patent application is incorporated herein by reference in its entirety.

### BACKGROUND

System virtualization or hardware virtualization refers to an abstraction of a hardware platform to create one or more simulated or virtualized computing environments called virtual machines (VMs). A program that controls the virtualization is referred to as a hypervisor or a virtual machine monitor. The current trend in many organizations is to move towards a hypervisor based environment for deploying critical applications on virtual machines owing to the resulting efficiency in the utilization of hardware resources. For example, virtual machines are used to deploy applications such as Microsoft® SharePoint, Microsoft® SQLServer, Microsoft® Exchange of Microsoft Corporation, virtual appliances, development and build environments, etc., to create a SharePoint virtual machine, an SQLServer virtual machine, etc.

With organizations increasingly deploying their most critical applications on the virtual machines, data can be stolen by duplicating a virtual machine and moving the duplicated virtual machine out of the organization's network. The stolen virtual machine can then be launched using a freely available desktop version of the virtual machine software. In another scenario, an external spurious virtual machine may be migrated into an organizational environment and made to function within the organizational environment posing a threat to the organization's network and data security. These threats are applicable to both desktop based and server based virtualization environments. Virtual machines of industry hypervisors can run on any free edition of hypervisors and vice versa.

Existing well known and accepted security solutions, for example, the trusted platform module (TPM) offers cryptographic features to secure information but requires a hardware upgrade to mother boards that support on-board TPM chips. The trusted platform module also involves significant expenditure to migrate an existing virtual environment to utilize the security solution provided by the TPM chips. Moreover, virtualization related features, for example, virtual machine migration, high availability (HA), etc. may not be supported by these existing security products. Furthermore, security solutions of some of these products are not extensible to all the industry leading hypervisors. Software-based solutions for securing virtual machines and virtualization environments are limited in the market and are incomplete.

Hence, there is a long felt but unresolved need for a computer implemented method and system that secures a virtual environment and virtual machines in the virtual environment. Moreover, there is a need for a computer implemented method and system that identifies and prevents any external virtual machines from functioning or migrating into an organizational environment and affecting an organization's network and data security. Furthermore, there is a need for a computer implemented method and system that restricts instantiation of an unauthorized virtual machine in a certified virtual environment.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for securing a virtual environment and virtual machines in the virtual environment. The computer implemented method and system disclosed herein identifies and prevents any external virtual machines from functioning or migrating into the virtual environment and affecting network and data security. The computer implemented method and system disclosed herein also prevents instantiation of an unauthorized virtual machine in a certified virtual environment.

In the computer implemented method and system disclosed herein, a credential authority server is provided for managing environment credentials of the virtual environment. A virtual machine shim is associated with each of the virtual machines. One or more hypervisor shims are associated with one or more hypervisors. Each of the hypervisors is configured to host and monitor one or more of the virtual machines in the virtual environment. The credential authority server provides, on request, environment credentials to each of the virtual machines and the hypervisors on authorization of each of the virtual machines and the hypervisors. The credential authority server receives requests for the environment credentials from each of the virtual machines and the hypervisors upon unavailability of pre-stored environment credentials in each of the virtual machines and the hypervisors respectively. The credential authority server receives the requests from each of the virtual machines and the hypervisors periodically and during boot-up of each of the virtual machines and the hypervisors. The credential authority server provides the environment credentials to each of the virtual machines and the hypervisors on authorization of each of the virtual machines and the hypervisors based on one or more authorization parameters associated with the requests. The authorization parameters for authorizing each of the virtual machines and the hypervisors comprise, for example, a single internet protocol address associated with the requests, a range of internet protocol addresses associated with the requests, a subnet associated with the requests, a media access control address, a domain name, a hostname, and any other unique identifier. The environment credentials provided by the credential authority server are stored in a secure data store within each of the virtual machines and the hypervisors. Each virtual machine shim and the hypervisor shims periodically contact the credential authority server at predetermined intervals of time for renewing the environment credentials stored in each of the virtual machines and the hypervisors.

Each virtual machine shim associated with each of the virtual machines communicates the provided environment credentials to the hypervisor shims for validation. The hypervisors associated with the hypervisor shims validate each of the virtual machines associated with each virtual machine shim based on the communicated environment credentials to allow instantiation of each of the virtual machines in the virtual environment. The environment credentials comprise, for example, a digital certificate, a security key, and a security name and password. The hypervisors validate each of the virtual machines to instantiate each of the virtual machines based on validation of the digital certificate, the security key, or the security name and password by the hypervisor shims. The hypervisors restrict the instantiation of the virtual machines, if the hypervisors fail to validate each of the virtual machines based on the communicated environment credentials. In an embodiment, the hypervisors forcefully terminate an unauthorized virtual machine from the virtual machines, if the virtual machine shim associated with the unauthorized virtual machine fails to communicate the environment credentials to the hypervisor shims for validation within a preconfigured period of time from the instantiation of the unauthorized virtual machine.

In an embodiment, the credential authority server manages the environment credentials of the virtual environment locally within the virtual environment. In another embodiment, the credential authority server manages the environment credentials of the virtual environment remotely as a virtualization security service over a public network herein referred to as virtualization security as a service (VSaaS). Each of the hypervisors in the virtual environment is either a native hypervisor or a hosted hypervisor. In case of a native hypervisor, the environment credentials provided by the credential authority server certify the native hypervisor in the virtual environment. In case of a hosted hypervisor, the environment credentials provided by the credential authority server certify a host operating system hosting the hypervisor.

In an embodiment, the hypervisor shims manage instantiation of the virtual machines locally from within the hypervisors in the virtual environment. In another embodiment, the hypervisor shims manage the instantiation of the virtual machines on a management virtual appliance that hosts the hypervisor shims in the virtual environment.

In the computer implemented method disclosed herein, one or more of the validated virtual machines are reinstantiated in the virtual environment. Each virtual machine shim associated with each of the reinstantiated validated virtual machines verifies whether the virtual environment in which the validated virtual machines are reinstantiated is certified. Each virtual machine shim terminates the reinstantiated validated virtual machines if the virtual environment is uncertified.

In an embodiment, one or more validated virtual machines are migrated from one of the hypervisors, herein referred to as a “first hypervisor”, to another one of the hypervisors herein referred to as a “second hypervisor” across the virtual environment.

Each virtual machine shim associated with each of the migrated virtual machines verifies whether the virtual environment is certified. Each virtual machine shim terminates the migrated virtual machines if the virtual environment is uncertified.

In another embodiment, one or more virtual machines are migrated from a first certified hypervisor among the hypervisors to a second certified hypervisor among the hypervisors across the virtual environment. The second certified hypervisor restricts instantiation of the migrated virtual machines if the second certified hypervisor fails to validate the communicated environment credentials of the migrated virtual machines.

In another embodiment, one or more virtual machines are migrated from a first hypervisor to a second hypervisor across the virtual environment. Each virtual machine shim associated with each of the migrated virtual machines verifies whether a host operating system hosting the second hypervisor is certified. Each virtual machine shim terminates the migrated virtual machines if the host operating system hosting the second hypervisor is uncertified.

In another embodiment, one or more virtual machines are migrated from a first host operating system hosting a first certified hypervisor to a second host operating system hosting a second certified hypervisor across the virtual environment. The second host operating system hosting the second certified hypervisor restricts instantiation of the migrated virtual machines, if the second host operating system fails to validate the communicated environment credentials of the migrated virtual machines.

In another embodiment, duplication of one or more virtual machines is detected in the virtual environment. The hypervisors restrict instantiation of the duplicated virtual machines when each virtual machine shim associated with each of the duplicated virtual machines fails to send requests for the environment credentials from the duplicated virtual machines to the credential authority server and/or fails to communicate the environment credentials provided by the credential authority server to the hypervisor shims for validation.

The computer implemented method and system disclosed herein provides a software based approach for authenticating the virtual machines with an environment authority, for example, the credential authority server located locally or on a network cloud, supplemented with the attestation and validation by the local hypervisor(s) without any tight coupling of environment credentials with an underlying system hardware. This allows any virtualization solution, employing the computer implemented method disclosed herein, to continue supporting virtual machine features such as migration, high availability (HA), load balancing, clustering, replication, etc., between virtual data centers of the virtual environment. The computer implemented method and system disclosed herein is compatible to work with industry leading hypervisors and with virtual machines hosting a variety of operating system (OS) flavors, for example, a Unix-based OS, a Linux-based OS, or a Windows® OS, etc. Moreover, during the configuration of private local area networks (LANs) or virtual local area network (VLAN) based virtual environments, the credential authority server is made available through the virtual machine shims and the hypervisor shims of the virtual environment, without causing any authentication issues during the configuration of the private LANs or VLAN environments.

The computer implemented method and system disclosed herein presents a software based approach that associates the virtual machines with a protected or certified virtual environment. This association ensures that the virtual machines function only within that certified virtual environment and are disabled when the virtual machines leave the certified virtual environment. The computer implemented method and system disclosed herein also enables addition and support of a trusted component, for example, a trusted platform module, with a privilege level to hypervisors and virtual machines to enable certification within the virtual environment. The virtual machines within the virtual environment establish a method to authenticate themselves using the environment credentials, herein referred to as “virtual machine self identity authentication”, during the boot up stages. Accordingly, rogue or unauthorized virtual machines are detected as early as possible and restricted from booting up in the certified virtual environment Likewise, authorized virtual machines restrict themselves from booting up in a security compromised virtual environment, such as on top of unauthorized hypervisors. The computer implemented method and system disclosed herein may be deployed on existing virtualization setups, as opposed to upgrading to costlier solutions involving hardware upgrades, and is compatible with all well known existing deployments of virtual machines.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for securing a virtual environment and virtual machines in the virtual environment.

FIG. 2A exemplarily illustrates association of shim layers with virtual machines and a hypervisor in a type 1 or native virtual environment.

FIG. 2B exemplarily illustrates association of shim layers with virtual machines and a hypervisor's host operating system in a type 2 or hosted virtual environment.

FIGS. 3-8 exemplarily illustrate implementation of security measures in different scenarios using the computer implemented method disclosed herein.

FIG. 9 illustrates a computer implemented system for securing a virtual environment and virtual machines in the virtual environment.

FIG. 10 exemplarily illustrates a computer implemented system for securing a virtual environment with virtualization security as a service (VSaaS) over the internet in a type 1 virtual environment.

FIG. 11 exemplarily illustrates seamless migration of a shimmed virtual machine between virtual data centers in the virtual environment.

FIG. 12 illustrates a computer implemented system for securing a virtual environment and virtual machines in the virtual environment using a management virtual appliance.

FIG. 13 exemplarily illustrates the architecture of a computer system employed for securing a virtual environment and virtual machines in the virtual environment.

FIGS. 14A-14B exemplarily illustrate a flowchart comprising the steps of securing a virtual environment and virtual machines in the virtual environment.

FIG. 15 exemplarily illustrates a state diagram of the computer implemented method for securing a virtual environment and virtual machines in the virtual environment.

### DETAILED DESCRIPTION OF THE INVENTION

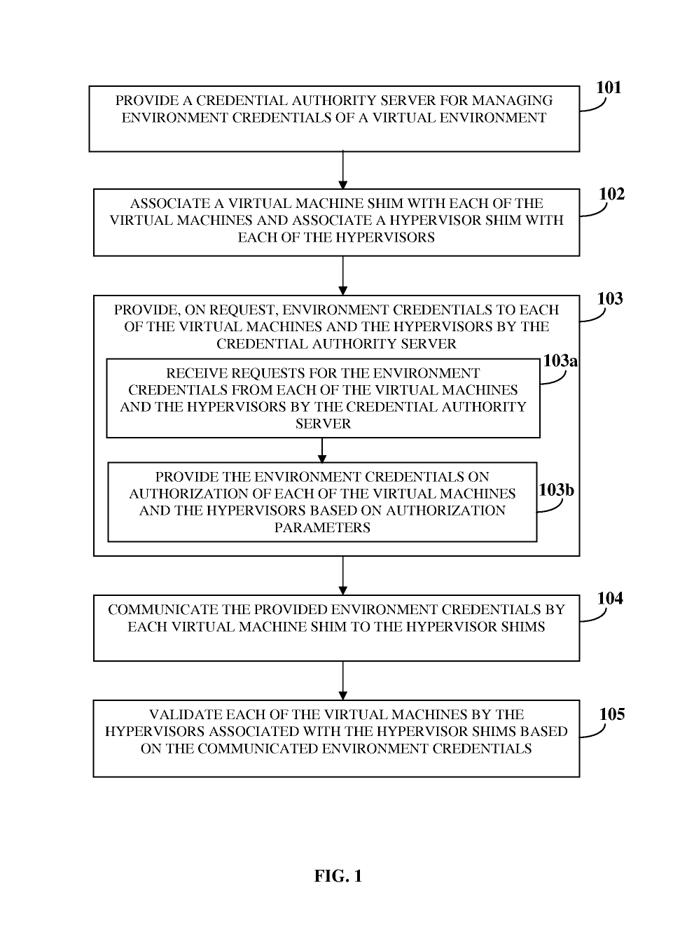

FIG. 1 illustrates a computer implemented method for securing a virtual environment and virtual machines in the virtual environment. As used herein, a “virtual machine” (VM) refers to a software implementation of a physical machine or computer, for example, a server, that executes programs similar to the physical machine. A virtual machine is a simulated software computer that, analogous to a physical computer, runs an operating system (OS) and applications. An OS installed on a virtual machine is referred to as a guest OS. The virtual machine runs on a control program called a hypervisor. A single hypervisor can host and monitor multiple virtual machines. The hypervisor uses virtualization software, for example, VMware ESX of VMware Inc. to run virtual machines. The hypervisor provides a central processing unit (CPU) and memory resources required by the virtual machines, and provides access to storage and network connectivity. In VMware terminology, the hypervisor is referred to as a host.

Referring to FIG. 1, a credential authority server is provided 101 for managing environment credentials of the virtual environment. As used herein, the term “virtual environment” refers to a computer-simulated virtual machine environment that represents, for example, an organization, a sub-division in an organization, a development lab, a testing lab, a data center, a group of virtual data centers, or an enterprise application, and comprises virtual machines. The unique credentials associated with such a virtual environment are termed as environment credentials. The computer implemented method disclosed herein secures virtual machines in the virtual environment from any unauthorized instantiations by providing software based self identity authentication. The computer implemented method disclosed herein secures virtual machines in the virtual environment from any unauthorized instantiations by enabling virtual machines within the virtual environment to authenticate themselves using the environment credentials, herein referred to as “software based virtual machine self identity authentication”, during the boot up stages.

The credential authority server manages the environment credentials and performs access control on one or more local area networks (LANs) and/or wide area networks (WANs) of the virtual environment. The credential authority server is installed, for example, on a Linux based machine. The credential authority server is an environment authority that generates and stores environment credentials, for example, a digital certificate, etc. The credential authority server is configured as an open secure socket layer (OpenSSL) server that receives environment credential requests and responds back with the environment credentials over secure socket layer (SSL) network connections.

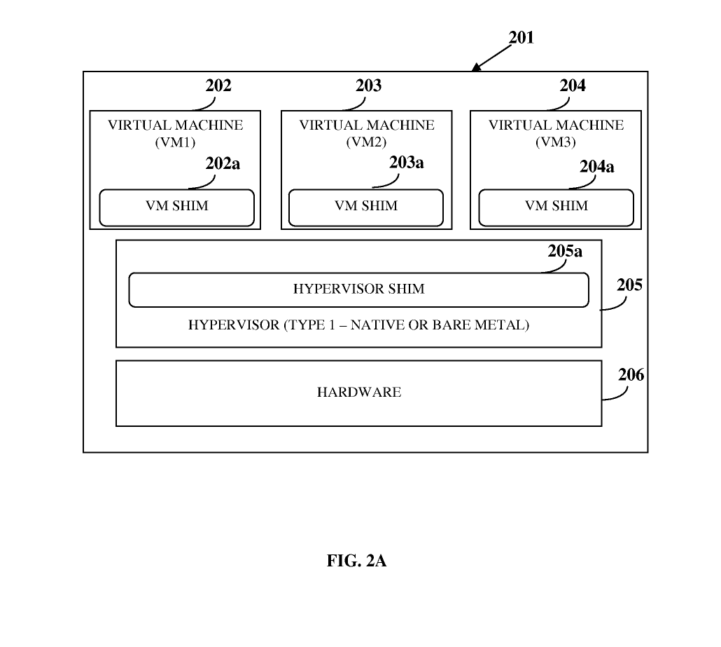

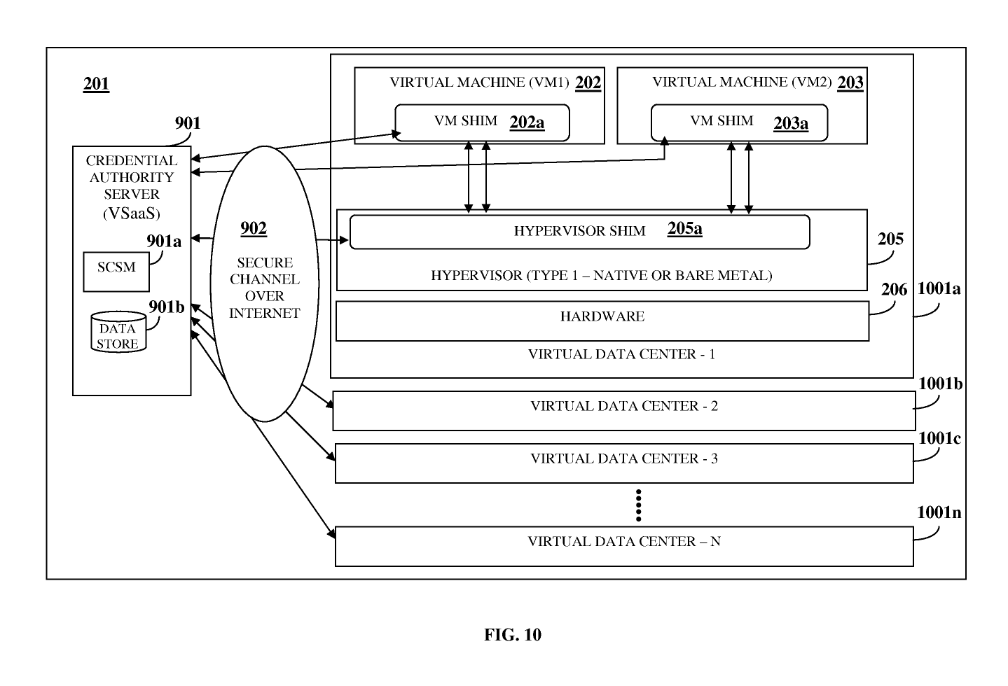

A virtual machine shim is associated 102 with each of the virtual machines in the virtual environment. One or more hypervisor shims are associated 102 with one or more hypervisors in the virtual environment. Each of the hypervisors is configured to host and monitor one or more of the virtual machines in the virtual environment. As used herein, a “virtual machine shim” refers to a client level security layer that envelops a virtual machine to elevate the virtual machine to an authorized state or a certified state. Also, as used herein, a “hypervisor shim” refers to a client level security layer that envelops a hypervisor or a host operating system (OS) hosting the hypervisor to elevate the hypervisor to an authorized state or a certified state. FIG. 2A exemplarily illustrates association of shim layers 202a, 203a and 204a with virtual machines 202, 203, and 204 and association of a shim layer 205a with a hypervisor 205 in a type 1 or native virtual environment. The type 1 virtual environment refers to a virtual environment where the hypervisor 205 runs on native or bare metal hardware. The shim layer 202a, 203a or 204a of the virtual machine 202, 203 or 204 is herein referred to as a “virtual machine shim” and the shim layer 205a of the hypervisor 205 or 205′ is herein referred to as a “hypervisor shim”. FIG. 2B exemplarily illustrates association of shim layers 202a and 203a with virtual machines 202 and 203 and association of a shim layer 205a with a hypervisor's 205′ host operating system 207 in a type 2 or hosted virtual environment. The type 2 virtual environment refers to a virtual environment where the hypervisor 205′ is hosted on top of an operating system 207 installed on hardware 206. The state of the hypervisor 205 or 205′ and the virtual machine 202, 203, or 204 after the installation of their respective shims 205a and 202a, 203a, or 204a is termed as “shimmed”. The hypervisor 205 or 205′ associated with a hypervisor shim 205a is herein referred to as a “shimmed hypervisor”. The virtual machine 202, 203, or 204 associated with a virtual machine shim 202a, 203a or 204a is herein referred to as a “shimmed virtual machine”. A shimmed virtual machine 202, 203, or 204 only loads on shimmed hypervisors 205 or 205′ that accept and authenticate the shimmed virtual machine 202, 203, or 204. Any shimmed virtual machine 202, 203, or 204 can load on any shimmed hypervisors 205 or 205′ with the same environment credentials. Unauthorized virtual machines are not allowed to run on authorized hypervisors 205 or 205′. Furthermore, authorized virtual machines 202, 203, and 204 are not allowed to instantiate or run on unauthorized hypervisors. The state of a virtual machine 202, 203, or 204 is said to be “unauthorized” if the virtual machine 202, 203, or 204 has never contacted the credential authority server 901 exemplarily illustrated in FIG. 9 or the virtual machine shim 202a, 203a, or 204a is not installed on the virtual machine 202, 203, or 204. Conversely, if the virtual machine 202, 203, or 204 is both shimmed and authorized to run on the hypervisor 205 or 205′ based on the environment credentials, the state of the virtual machine 202, 203, or 204 is referred to as “certified” or “authorized”. The state of the hypervisor 205 or 205′ after being shimmed and after receiving the environment credentials and storing the environment credentials securely is referred to as “certified” or “authorized”.

The credential authority server 901 provides 103, on request, environment credentials to each of the virtual machines 202, 203, and 204 and the hypervisors 205 or 205′ on authorization of each of the virtual machines 202, 203, and 204 and the hypervisors 205 or 205′. The credential authority server 901 receives 103a requests for the environment credentials from each of the virtual machines 202, 203, and 204 and the hypervisors 205 or 205′ upon unavailability of pre-stored environment credentials in each of the virtual machines 202, 203, and 204 and the hypervisors 205 or 205′ respectively. For example, a hypervisor 205 or 205′ checks for environment credentials in its data store 205b, and upon unavailability of environment credentials in its data store 205b, requests the environment credentials from the credential authority server 901. Similarly, each of the virtual machines 202, 203, and 204 identifies its own flavor, obtains the hostname of the hypervisor 205 or 205′ before login, and checks for environment credentials in its respective data store 202b, 203b, and 204b. Upon unavailability of environment credentials in the respective data stores 202b, 203b, and 204b, the virtual machines 202, 203, and 204 send requests for the environment credentials to the credential authority server 901. The credential authority server 901 receives the requests from each of the virtual machines 202, 203, and 204 and the hypervisors 205 or 205′ periodically and during boot-up of each of the virtual machines 202, 203, and 204 and the hypervisors 205 or 205′. The credential authority server 901 provides 103b the requested environment credentials to each of the virtual machines 202, 203, and 204 and the hypervisors 205 or 205′ on authorization of each of the virtual machines 202, 203, and 204 and the hypervisors 205 or 205′ based on one or more authorization parameters associated with the requests. The authorization parameters for authorizing each of the virtual machines 202, 203, and 204 and the hypervisors 205 or 205′ comprise, for example, a single internet protocol address associated with the requests, a range of internet protocol addresses associated with the requests, a subnet associated with the requests, a media access control address, a domain name, a hostname, and any other unique identifier. The credential authority server 901 performs authorization to detect unauthorized virtual machines and unauthorized hypervisors. The environment credentials provided by the credential authority server 901 are stored in a secure data store 202b, 203b, 204b, and 205b within each of the virtual machines 202, 203, and 204 and the hypervisors 205 or 205′ respectively. In an embodiment, each virtual machine shim 202a, 203a, or 204a and the hypervisor shims 205a periodically contact the credential authority server 901 at predetermined intervals of time for renewing the environment credentials stored in each of the virtual machines 202, 203, or 204 and the hypervisors 205 or 205′.

Each virtual machine shim 202a, 203a, or 204a associated with each of the virtual machines 202, 203, or 204 communicates 104 the provided environment credentials to the hypervisor shims 205a for validation. Each virtual machine shim 202a, 203a, or 204a establishes communication with the hypervisor shims 205a to transmit the environment credentials to the hypervisors 205 or 205′. The hypervisor shims 205a validate the environment credentials and determine if the virtual machines 202, 203, and 204 are authorized to execute on the hypervisors 205 or 205′. If the virtual machines 202, 203, and 204 are authorized to work on the hypervisors 205 or 205′, the virtual machines 202, 203, and 204 are deemed certified or authorized. If the virtual machines 202, 203, and 204 are not authorized to work on the hypervisors 205 or 205′, the hypervisors 205 or 205′ restrict instantiation of the virtual machines 202, 203, and 204 or shut down the virtual machines 202, 203, and 204.

The hypervisors 205 or 205′ associated with the hypervisor shims 205a validate 105 each of the virtual machines 202, 203, or 204 associated with each virtual machine shim 202a, 203a, or 204a based on the communicated environment credentials to allow instantiation of each of the virtual machines 202, 203, or 204 in the virtual environment 201. The environment credentials comprise, for example, a digital certificate, a security key, and a security name and password. The hypervisors 205 or 205′ validate each of the virtual machines 202, 203, and 204 to instantiate each of the virtual machines 202, 203, and 204 based on validation of the digital certificate, the security key, and the security name and password by the hypervisor shims 205a. The hypervisors 205 or 205′ restrict the instantiation of the virtual machines 202, 203, and 204, if the hypervisors 205 or 205′ fail to validate each of the virtual machines 202, 203, and 204 based on the communicated environment credentials. In an embodiment, the hypervisors 205 or 205′ forcefully terminate an unauthorized virtual machine from the virtual machines 202, 203, and 204, if the virtual machine shim 202a, 203a, or 204a associated with the unauthorized virtual machine fails to communicate the environment credentials to the hypervisor shims 205a for validation within a preconfigured period of time from instantiation or boot-up of the unauthorized virtual machine.

In an embodiment, the credential authority server 901 manages the environment credentials of the virtual environment 201 locally within the virtual environment 201. In another embodiment, the credential authority server 901 manages the environment credentials of the virtual environment 201 remotely as a virtualization security service over a public network, herein referred to as virtualization security as a service (VSaaS). Each of the hypervisors is either a native hypervisor 205 or a hosted hypervisor 205′. In case of a native hypervisor 205, the environment credentials provided by the credential authority server 901 certify the native hypervisor 205 in the virtual environment 201. In case of a hosted hypervisor 205′, the environment credentials provided by the credential authority server 901 certify a host operating system 207 hosting the hypervisor 205′.

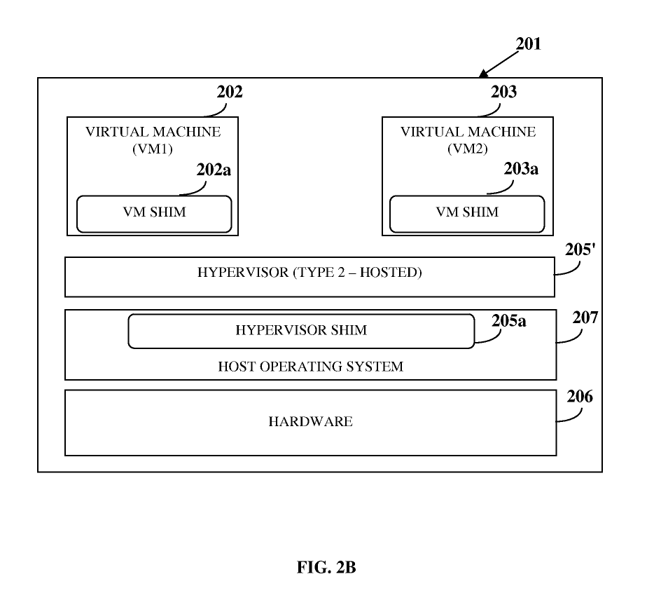

FIG. 3 exemplarily illustrates an implementation of security measures in an example scenario in which one or more of the validated virtual machines 202, 203, or 204 are reinstantiated 301 in the virtual environment 201. Each virtual machine shim 202a, 203a, or 204a associated with each of the reinstantiated validated virtual machines 202, 203, or 204 again verifies 302 whether the virtual environment 201 in which the validated virtual machines 202, 203, or 204 are reinstantiated is certified. Each virtual machine shim 202a, 203a, or 204a terminates 303 the reinstantiated validated virtual machines 202, 203, or 204 if the virtual environment 201 is uncertified.

The virtual environment 201 is deemed certified if the hypervisors 205 or 205′ and the virtual machines 202, 203, and 204 have access to a certification authority, for example, the credential authority server 901 that can validate and/or reissue environment credentials. Furthermore, the virtual environment 201 is deemed certified if the hypervisors 205 or 205′ are associated or successfully installed with the hypervisor shims 205a. The virtual environment 201 is deemed certified when the hypervisor shims 205a, during the environment credentials request, have been successfully authorized based on the authorization parameters and have received the environment credentials by the credential authority server 901. The virtual environment 201 is deemed uncertified if the hypervisors 205 or 205′ and the virtual machines 202, 203, and 204 have never contacted the credential authority server 901 when the environment credentials of the hypervisors 205 or 205′ and the virtual machines 202, 203, and 204 have expired, if the hypervisors 205 or 205′ are not associated with the hypervisor shims 205a, if the hypervisor shims 205a have not been successfully authorized based on the authorization parameters, etc. Each of the validated virtual machines 202, 203, and 204 detects its instantiation in an uncertified virtual environment and shuts itself down.

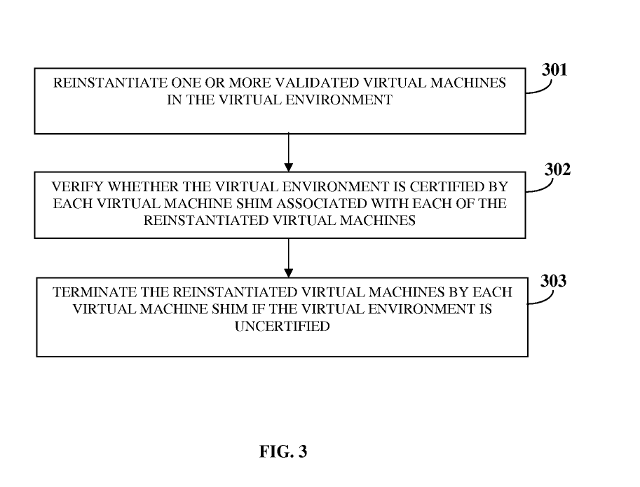

FIG. 4 exemplarily illustrates another implementation of security measures in an example migration scenario, according to the computer implemented method disclosed herein. One or more validated virtual machines 202 or 203 are migrated 401 from one of the hypervisors 205 or 205′ herein referred to as a “first hypervisor” to another one of the hypervisors 205 or 205′ herein referred to as a “second hypervisor” across the virtual environment 201. Each virtual machine shim 202a or 203a associated with each of the migrated virtual machines 202 or 203 again verifies 402 whether the virtual environment 201 is certified. Each virtual machine shim 202a or 203a terminates 403 the migrated virtual machines 202 or 203 if the virtual environment 201 is uncertified. For example, if an authorized virtual machine 202 or 203 is migrated to a hypervisor without the hypervisor shim 205a, the virtual machine shim 202a or 203a associated with authorized virtual machine 202 or 203 shuts down the authorized virtual machine 202 or 203.

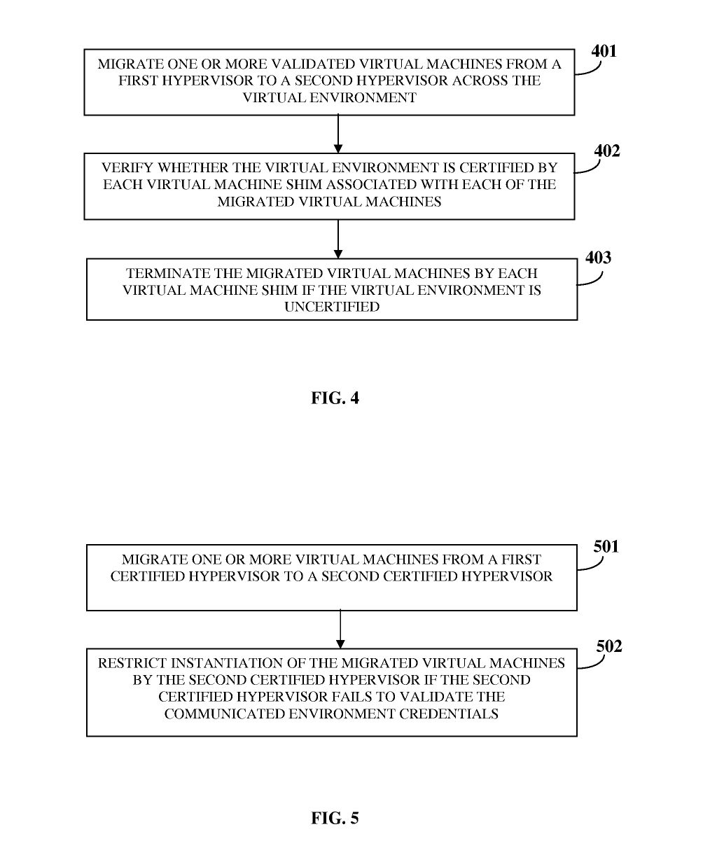

FIG. 5 exemplarily illustrates another implementation of security measures in an example migration scenario, according to the computer implemented method disclosed herein. One or more virtual machines 202 or 203 are migrated 501 from a first certified hypervisor 205 or 205′ to a second certified hypervisor 205 or 205′ across the virtual environment 201. The second certified hypervisor 205 or 205′ restricts 502 instantiation of the migrated virtual machines 202 or 203 if the second certified hypervisor 205 or 205′ fails to validate the communicated environment credentials of the migrated virtual machines 202 or 203. For example, the second certified hypervisor 205 or 205′ may fail to validate the communicated environment credentials if the environment credentials of the migrated virtual machines 202 or 203 and the second certified hypervisor 205 or 205′ differ from each other. If the environment credentials of the migrated virtual machines 202 or 203 and the second certified hypervisor 205 or 205′ differ from each other, the second certified hypervisor 205 or 205′ restricts instantiation or shuts down the migrated virtual machines 202 or 203.

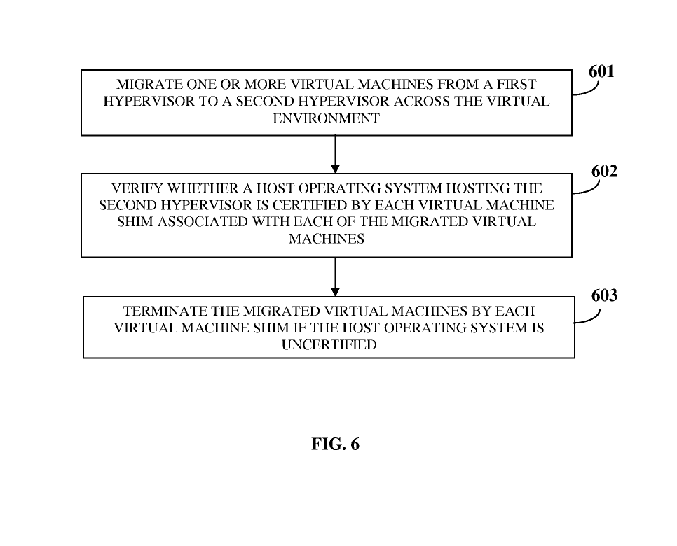

FIG. 6 exemplarily illustrates another implementation of security measures in another example migration scenario, according to the computer implemented method disclosed herein. One or more virtual machines 202 or 203 are migrated 601 from a first hypervisor 205 or 205′ to a second hypervisor 205 or 205′ across the virtual environment 201. Each virtual machine shim 202a or 203a associated with each of the migrated virtual machines 202 or 203 verifies 602 whether a host operating system 207 hosting the second hypervisor 205 or 205′ is certified. Each virtual machine shim 202a or 203a terminates 603 the migrated virtual machines 202 or 203 if the host operating system 207 hosting the second hypervisor 205 or 205′ is uncertified.

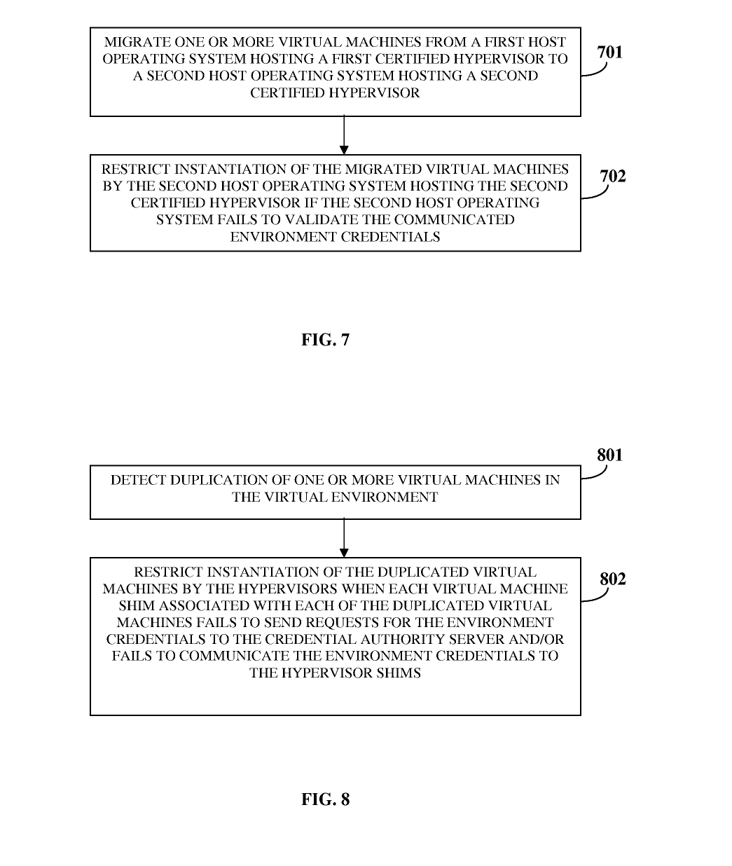

FIG. 7 exemplarily illustrates another implementation of security measures in another example migration scenario, according to the computer implemented method disclosed herein. In this scenario, one or more virtual machines 202 or 203 are migrated 701 from a first host operating system 207 hosting a first certified hypervisor 205 or 205′ to a second host operating system 207 hosting a second certified hypervisor 205 or 205′ across the virtual environment 201. The second host operating system 207 hosting the second certified hypervisor 205 or 205′ restricts 702 instantiation of the migrated virtual machines 202 or 203 if the second host operating system 207 fails to validate the communicated environment credentials of the migrated virtual machines 202 or 203.

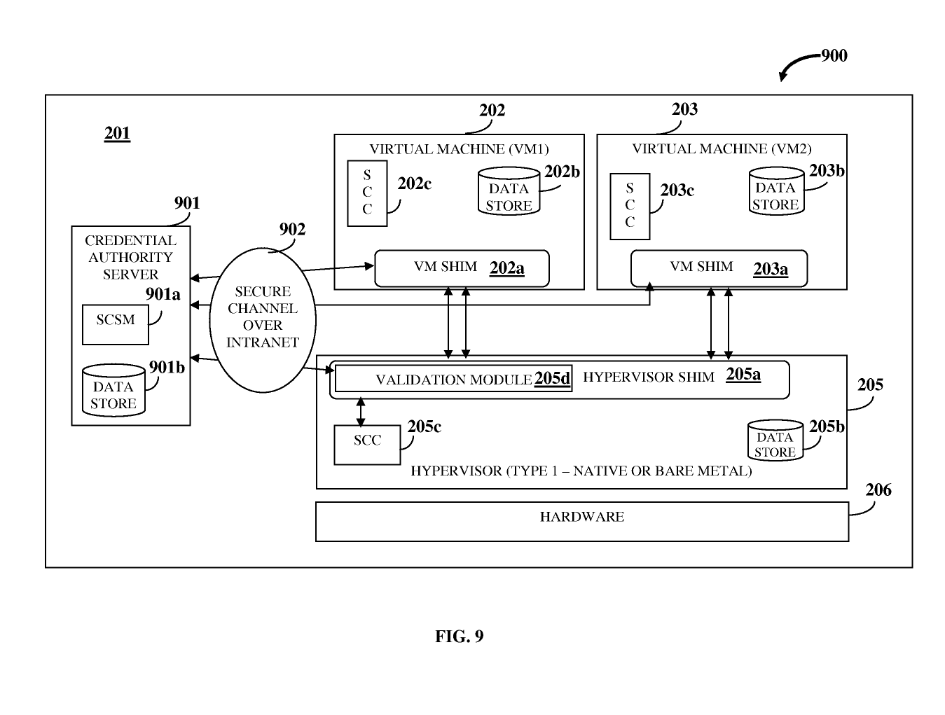

FIG. 8 exemplarily illustrates another implementation of security measures in another example scenario, according to the computer implemented method disclosed herein. In this scenario, duplication of one or more virtual machines 202 or 203 is detected 801 in the virtual environment 201. The hypervisors 205 or 205′ restrict 802 instantiation of the duplicated virtual machines 202 or 203 when each virtual machine shim 202a or 203a associated with each of the duplicated virtual machines 202 or 203 fails to send requests for the environment credentials from the duplicated virtual machines 202 or 203 to the credential authority server 901 and/or fails to communicate the environment credentials provided by the credential authority server 901 to the hypervisor shims 205a for validation.

The computer implemented method disclosed herein is a software based approach for authenticating the virtual machines 202 or 203 with an environment authority, for example, the credential authority server 901 located locally or on a network cloud, supplemented with the attestation and validation by the local hypervisor(s) 205 or 205′ without any tight coupling of credentials with the underlying system hardware 206. This allows any virtualization solution, employing the computer implemented method disclosed herein, to continue supporting virtual machine features such as migration, high availability (HA), load balancing, clustering, replication, etc. between virtual data centers.

The computer implemented method and system disclosed herein presents a software based approach that associates a virtual machine 202 or 203 with a protected or certified virtual environment 201. This association ensures that the virtual machine 202 or 203 functions only within the virtual environment 201 and is disabled when the virtual machine 202 or 203 leaves the certified virtual environment 201. The virtual machines 202 or 203 within the virtual environment 201 establish a method to authenticate themselves using the environment credentials, herein referred to as “virtual machine self identity authentication”, during the boot up stage. Accordingly, rogue or unauthorized virtual machines are restricted from booting up within the certified virtual environment 201. Likewise authorized virtual machines 202 or 203 restrict themselves from booting up in a security compromised environment, such as on top of uncertified hypervisors. The computer implemented method and system disclosed herein may be deployed on existing virtual environment setups without any hardware upgrades and is compatible with all well known existing deployments of virtual machines 202 or 203.

FIG. 9 illustrates a computer implemented system 900 for securing a virtual environment 201 and virtual machines 202 and 203 in the virtual environment 201. The computer implemented system 900 disclosed herein comprises a credential authority server 901, virtual machine (VM) shims 202a and 203a associated with the virtual machines 202 and 203, one or more hypervisor shims 205a associated with one or more hypervisors 205, and one or more secure channels 902 over a network. The network is, for example, a private network, the internet, an intranet as exemplarily illustrated in FIG. 9, a public network, etc.

The credential authority server 901 is configured as an open secure socket layer (OpenSSL) server that manages environment credentials of the virtual environment 201. In an embodiment, the credential authority server 901 manages the environment credentials of the virtual environment 201 locally within the virtual environment 201. In another embodiment, the credential authority server 901 manages the environment credentials of the virtual environment 201 remotely as a virtualization security service over a public network. The credential authority server 901 comprises a secure communication server module (SCSM) 901a and a secure data store 901b. The secure communication server module 901a receives and responds to requests for the environment credentials over secure network connections or channels 902, for example, secure socket layer (SSL) connections. The credential authority server 901 receives requests for environment credentials from each of the virtual machines 202 and 203 and the hypervisor 205 periodically and during boot-up of the virtual machines 202 and 203 and the hypervisor 205. The credential authority server 901 generates and stores the environment credentials in the secure data store 901b. The virtual machine shims 202a and 203a and the hypervisor shim 205a are configured to periodically contact the credential authority server 901 at predetermined intervals of time for renewing the environment credentials stored in each of the virtual machines 202 and 203 and the hypervisor 205. The credential authority server 901 provides the requested environment credentials to each of the virtual machines 202 and 203 and the hypervisor 205 on authorization of each of the virtual machines 202 and 203 and the hypervisor 205 based on one or more authorization parameters, for example, a single internet protocol address, a range of internet protocol addresses, a subnet, a media access control address, a domain name, a hostname, other unique identifiers, etc. associated with the requests.

Each of the virtual machines 202 and 203 associated with virtual machine shims 202a and 203a respectively comprises a secure communication client (SCC) 202c or 203c and a secure data store 202a or 203b. The secure communication client 202c or 203c transmits requests for environment credentials to the credential authority server 901 and communicates the environment credentials to the hypervisor shim 205a associated with the hypervisor 205 via the virtual machine shim 202a or 203a for validation. The secure data store 202b and 203b of each of the virtual machines 202 and 203 stores the environment credentials provided by the credential authority server 901.

The hypervisor 205 is configured to host and monitor one or more virtual machines 202 and 203 in the virtual environment 201 and to validate the virtual machines 202 and 203 based on the communicated environment credentials. The hypervisor 205 exemplarily illustrated in FIG. 9 is a hypervisor 205 that runs on native or bare metal hardware in a type 1 virtual environment.

The hypervisor 205 associated with the hypervisor shim 205a comprises a secure communication client 205c and a secure data store 205b. The secure communication client 205c transmits requests for the environment credentials to the credential authority server 901 periodically or during boot up. The secure data store 205b stores the environment credentials provided by the credential authority server 901. In an embodiment, the hypervisor shim 205a manages instantiation of the virtual machines 202 and 203 locally from within the hypervisor 205 in the virtual environment 201. The hypervisor shim 205a comprises a validation module 205d. The validation module 205d is configured as an open secure socket layer (OpenSSL) server to receive validation requests from the virtual machines 202 and 203 via the virtual machine shims 202a and 203a respectively. The validation module 205d receives and validates the environment credentials communicated by one or more virtual machine shims 202a and 203a and enables the hypervisor 205 to validate the virtual machines 202 and 203 associated with the virtual machine shims 202a and 203a respectively based on the communicated environment credentials to allow instantiation of each of the virtual machines 202 and 203 in the virtual environment 201. The environment credentials for validating the virtual machines 202 and 203 comprises, for example, a digital certificate, a security key, a security name and password, etc. The hypervisor 205 validates each of the virtual machines 202 and 203 to instantiate each of the virtual machines 202 and 203 based on validation of, for example, the digital certificate, a security key, a security name and password, etc. by the validation module 205d of the hypervisor shim 205a.

The hypervisor is, for example, either a native hypervisor 205 or a hosted hypervisor 205′. In case of a native hypervisor 205 as exemplarily illustrated in FIG. 2A, the environment credentials provided by the credential authority server 901 certify the native hypervisor 205 within the virtual environment 201. In case of a hosted hypervisor 205′ as exemplarily illustrated in FIG. 2B, the environment credentials provided by the credential authority server 901 certify a host operating system 207 hosting the hypervisor 205′ within the virtual environment 201. The hypervisor 205 restricts instantiation of the virtual machines 202 and 203 if the hypervisor 205 fails to validate each of the virtual machines 202 and 203 based on the communicated environment credentials. In an embodiment, the hypervisor 205 forcefully terminates an unauthorized virtual machine from the virtual machines 202 and 203, if the virtual machine shim 202a or 203a associated with the unauthorized virtual machine fails to communicate the environment credentials to the hypervisor shim 205a for validation within a preconfigured period of time from instantiation or boot-up of the unauthorized virtual machine.

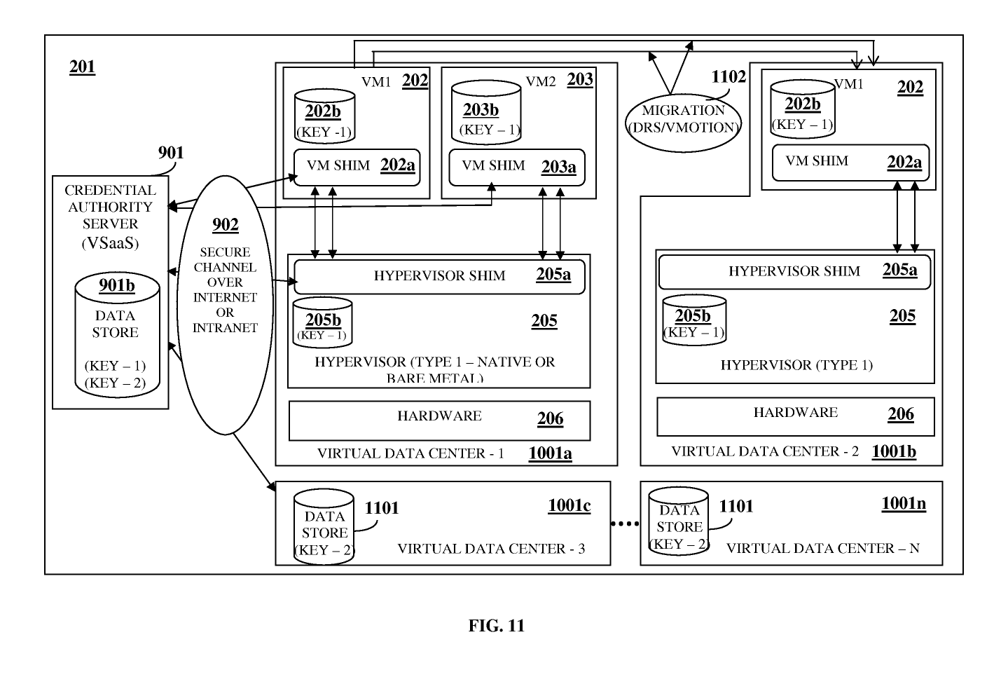

FIG. 10 exemplarily illustrates a computer implemented system for securing a virtual environment 201 with virtualization security as a service (VSaaS) over the internet in a type 1 virtual environment. The computer implemented system disclosed herein comprises a remote credential authority server 901, one or more virtual machines 202 and 203 running in virtual data centers 1001a, 1001b, 1001c to 1001n, and multiple shimmed hypervisors 205 running in the virtual data centers 1001a, 1001b, 1001c to 1001n. The virtual data centers 1001a, 1001b, 1001c to 1001n are data centers that house multiple virtual machines 202 and 203 and hypervisors 205 in the virtual environment 201. The hypervisors 205 exemplarily illustrated in FIG. 10 are hypervisors 205 that run on native or bare metal hardware in a type 1 virtual environment. The credential authority server 901 manages environment credentials for the multiple virtual data centers 1001a, 1001b, 1001c to 1001n across the virtual environment 201 by providing environment credentials over secure channels 902, for example, secure socket layer (SSL) channels of a public network, for example, the internet. The virtual machine (VM) shims 202a and 203a associated with the virtual machines 202 and 203 respectively communicate the environment credentials provided by the remote credential authority server 901 to one or more hypervisor shims 205a associated with the hypervisors 205 in their respective virtual data centers 1001a, 1001b, 1001c to 1001n. The hypervisors 205 validate the virtual machines 202 and 203 associated with the virtual machine shims 202a and 203a respectively based on the communicated environment credentials to allow instantiation of each of the virtual machines 202 and 203 in their respective virtual data centers 1001a, 1001b, 1001c to 1001n in the virtual environment 201.

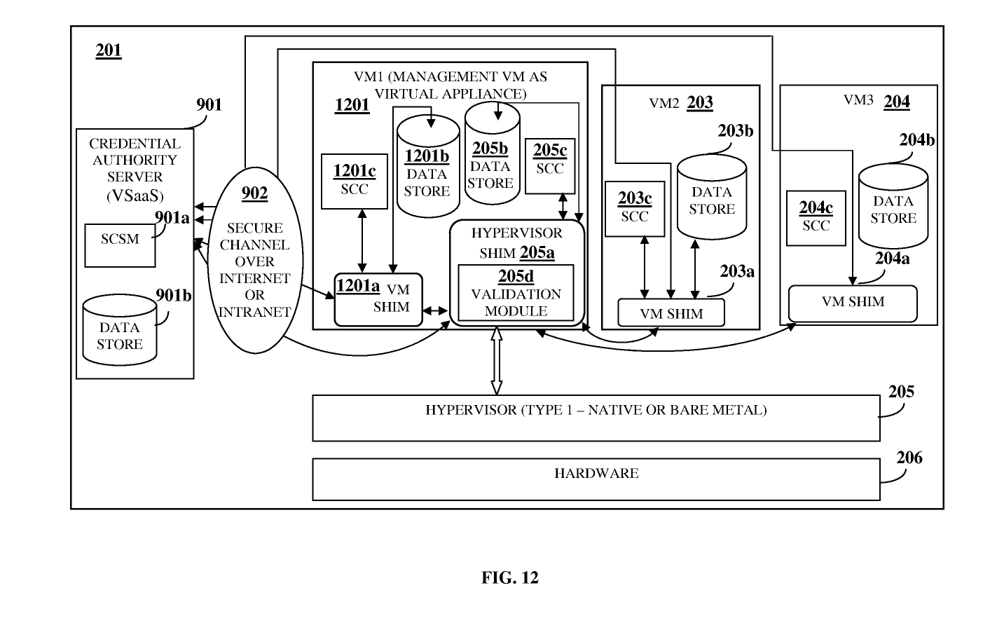

FIG. 11 exemplarily illustrates seamless migration of a shimmed virtual machine (VM) 202 or 203 between virtual data centers 1001a, 1001b, 1001c to 1001n in the virtual environment 201. In the computer implemented method and system disclosed herein, one or more of the validated virtual machines 202 and 203 running on one of the hypervisors 205 in one of the virtual data centers 1001a, 1001b, 1001c to 1001n is migrated to another one of the hypervisors 205 in another one of the virtual data centers 1001a, 1001b, 1001c to 1001n across the virtual environment 201. For example, the validated virtual machine 202 running on the hypervisor 205 in the virtual data center-1 1001a is migrated to another one of the hypervisors 205 in the virtual data center-2 1001b across the virtual environment 201. Migration 1102 of the virtual machine 202 is achieved, for example, via a distributed resource scheduler (DRS) or VMotion of VMware, Inc. The distributed resource scheduler continuously monitors the migration and utilization of the virtual machine 202 across the virtual environment 201 and intelligently allocates available resources among the virtual machines 202 and 203. VMotion allows the migration of operational guest virtual machines, for example, the virtual machine 202 between the virtual data centers, for example, virtual data center-1 1001a and virtual data center-2 1001b. As exemplarily illustrated in FIG. 11, the virtual machine 202 is migrated between the hypervisor 205 of the virtual data center-1 1001a and the hypervisor 205 of the virtual data center-2 1001b. The hypervisors 205 of the virtual data center-1 1001a and the virtual data center-2 1001b belong to the same group since the same environment credential or key, for example, key-1 is present in their respective data stores 205b. Similarly, migrations of the virtual machines 202 and 203 are allowed between the hypervisor 205 of the virtual data center-3 1001c and the hypervisor 205 of the virtual data center-n 1001n, since these hypervisors 205 possess the same environment credential or key, for example, key-2 in their respective data stores 1101. As exemplarily illustrated in FIG. 11, the environment credential keys, key-1 and key-2 reside in the secure data store 901b of the credential authority server 901 for validation against respective environment credential keys from the virtual machines 202 and 203 and/or the hypervisors 205 during the validation phase.

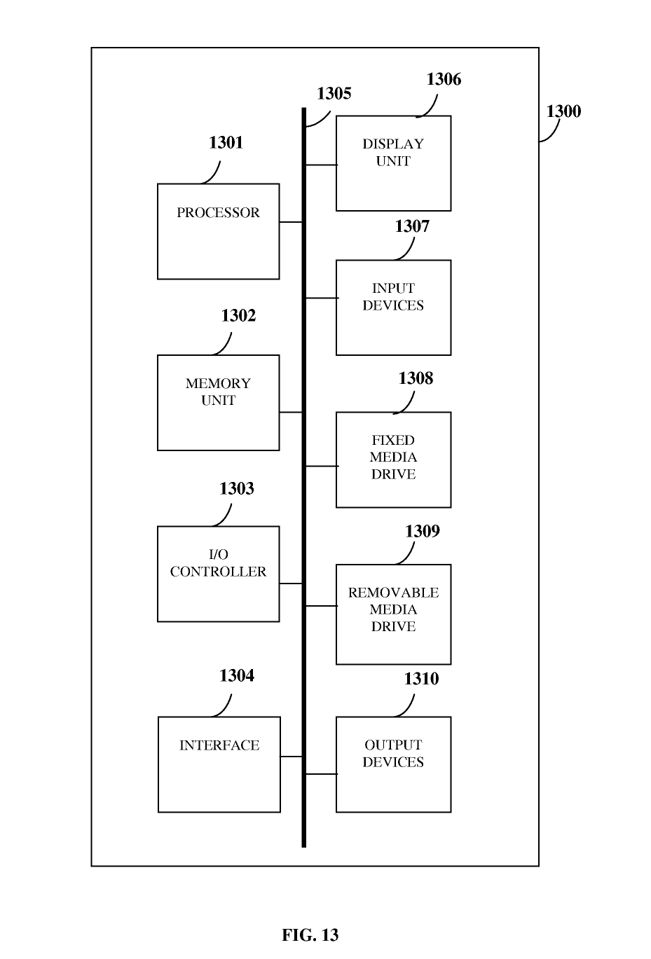

Although the computer implemented method and system 900 disclosed herein and its embodiments have been described with reference to the functioning of the hypervisor shim 205a on the hypervisor 205 for receiving environment credentials from the credential authority server 901 and validating the virtual machines 202 and 203 in the virtual environment 201, the scope of the computer implemented method and system 900 disclosed herein is not limited to the hypervisor shim 205a deployed on the hypervisor 205. In an embodiment, the computer implemented method and system 900 disclosed herein may be extended to include a configuration where the hypervisor shim 205a is deployed on a management virtual machine in the form of a management virtual appliance 1201, as exemplarily illustrated in FIG. 12. This embodiment is utilized when the hypervisor 205 in the virtual environment 201 may not allow itself to be updated or associated with a shim layer such as the hypervisor shim 205a, if the hypervisor 205 is, for example, an embedded hypervisor. In this scenario, the functionality of the hypervisor shim 205a is performed by another authorized or certified virtual machine referred to as the management virtual appliance 1201.

FIG. 12 exemplarily illustrates a computer implemented system for securing a virtual environment 201 and virtual machines 203 and 204 in the virtual environment 201 using a management virtual appliance 1201. The credential authority server 901 manages the environment credentials of the virtual environment 201 remotely as a virtualization security service by providing environment credentials over secure channels 902, for example, secure socket layer (SSL) channels of a network, for example, the internet, an intranet, etc. The operation of the computer implemented system in FIG. 12 is similar to the operation of the computer implemented system 900 in FIG. 9 with the exception that the hypervisor shim 205a is deployed within an independent management custom virtual machine herein referred to as the management virtual appliance 1201. The management virtual appliance 1201 refers to a software appliance configured to run inside a virtual machine that is specific to the virtual environment 201 of the computer implemented system disclosed herein. As exemplarily illustrated in FIG. 12, the hypervisor shim 205a is deployed within the management virtual appliance 1201 and manages the instantiation of the virtual machines 203 and 204 from the management virtual appliance 1201 hosting the hypervisor shim 205a in the virtual environment 201. The functionality of the hypervisor shim 205a is performed by the management virtual appliance 1201. The contents of the management virtual appliance 1201 comprise a pre-configured, pre-hardened and light weight operating system, a virtual machine (VM) shim 1201a, the hypervisor shim 205a, respective data stores 1201b and 205b, and respective secure communication clients (SCCs) 1201c and 205c. The hypervisor shim 205a detects and accesses guest virtual machines 203 and 204, and in certain scenarios instructs the hypervisor 205 running on native or bare metal hardware in the type 1 virtual environment, to restrict the instantiation of the guest virtual machines 203 and 204 by shutting down the guest virtual machines 203 and 204 in case they are not certified.

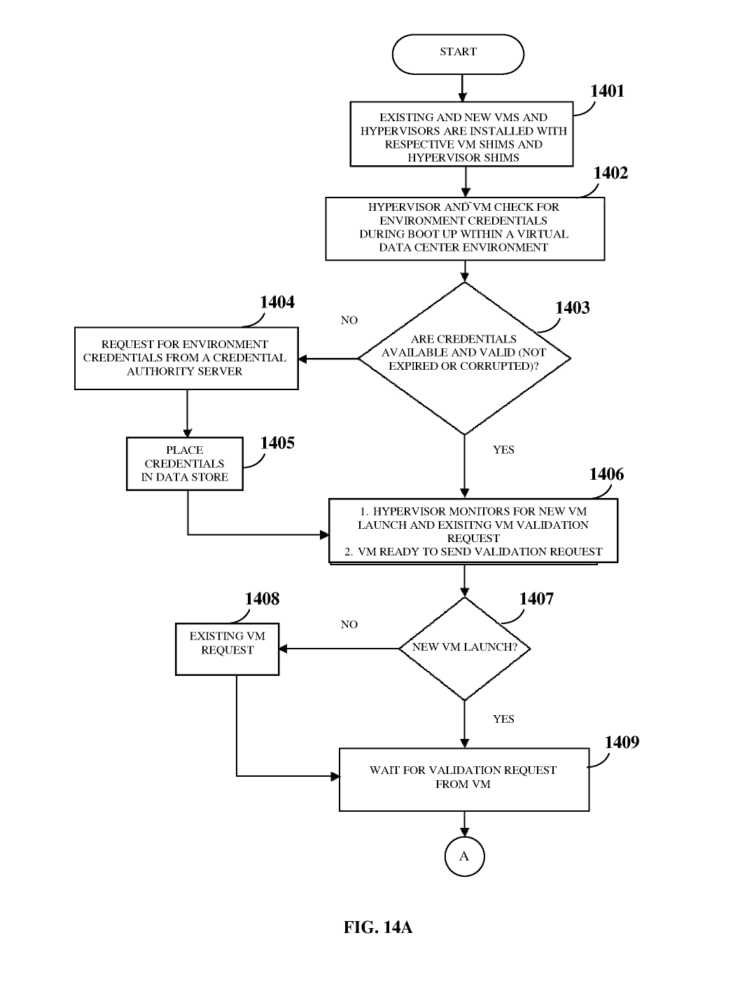

FIG. 13 exemplarily illustrates the architecture of a computer system 1300 employed for securing a virtual environment 201 and virtual machines 202 and 203 in the virtual environment 201. The computer system 1300 is employed by the credential authority server 901, the virtual machines 202 and 203, and the hypervisors 205 in the virtual environment 201. The computer system 1300 comprises a processor 1301, a memory unit 1302 for storing programs and data, an input/output (I/O) controller 1303, and a display unit 1306 communicating via a data bus 1305. The memory unit 1302 comprises a random access memory (RAM) and a read only memory (ROM). The computer system 1300 comprises one or more input devices 1307, for example, a keyboard such as an alphanumeric keyboard, a mouse, a joystick, etc. The input devices 1307 are used for inputting data into the computer system 1300. The input/output (I/O) controller 1303 controls the input and output actions performed by a user. The computer system 1300 communicates with other computer systems through an interface 1304, comprising, for example, a Bluetooth™ interface, an infrared (IR) interface, a WiFi interface, a universal serial bus interface (USB), a local area network (LAN), a wide area network (WAN) interface, etc.

The processor 1301 is an electronic circuit that can execute computer programs. The memory unit 1302 is used for storing programs, applications, and data. For example, the virtual machine shims 202a and 203a and the hypervisor shim 205a are stored on the memory unit 1302 of the computer system 1300. The memory unit 1302 is, for example, a random access memory (RAM) or another type of dynamic storage device that stores information and instructions for execution by the processor 1301. The memory unit 1302 also stores temporary variables and other intermediate information used during execution of the instructions by the processor 1301. The computer system 1300 further comprises a read only memory (ROM) or another type of static storage device that stores static information and instructions for the processor 1301. The data bus 1305 permits communication between the modules, for example, 202a, 202c, 203a, 203c, 205a, 205c, 205d, 901a, etc. of the computer implemented system 900 disclosed herein.

Computer applications and programs are used for operating the computer system 1300. The programs are loaded onto the fixed media drive 1308 and into the memory unit 1302 of the computer system 1300 via the removable media drive 1309. In an embodiment, the computer applications and programs may be loaded directly through a network. Computer applications and programs are executed by double clicking a related icon displayed on the display unit 1306 using one of the input devices 1307. A user interacts with the computer system 1300 using a graphical user interface (GUI) of the display unit 1306.

The computer system 1300 employs an operating system for performing multiple tasks. The operating system manages execution of, for example, the virtual machine shim 202a or 203a and the hypervisor shim 205a provided on the computer system 1300. The operating system further manages security of the computer system 1300, peripheral devices connected to the computer system 1300, and network connections. The operating system employed on the computer system 1300 recognizes keyboard inputs of a user, output display, files and directories stored locally on the fixed media drive 1308, for example, a hard drive. The operating system executes different programs, for example, a web browser, an electronic mail client, etc., initiated by the user with the help of the processor 1301, for example, a central processing unit (CPU). The operating system monitors the use of the processor 1301.

The virtual machine shim 202a or 203a and the hypervisor shim 205a are installed in the computer system 1300 and the instructions are stored in the memory unit 1302. The environment credentials are transmitted from the credential authority server 901 to the hypervisor shim 205a and the virtual machine shim 202a or 203a installed in the computer system 1300 of the virtual environment 201 or hardware 206 via the interface 1304 or a network. A user initiates the execution of the virtual machine shim 202a or 203a and the hypervisor shim 205a by double clicking the icon for the virtual machine shim 202a or 203a and the hypervisor shim 205a respectively on the display unit 1306. The execution of the virtual machine shim 202a or 203a and the hypervisor shim 205a is automatically initiated on installing the virtual machine shim 202a or 203a and the hypervisor shim 205a respectively in the virtual environment 201 or hardware 206. The processor 1301 retrieves instructions for securing the virtual environment 201 and the virtual machines 202a and 203a in the virtual environment 201 from the program memory in the form of signals. A program counter (PC) determines the locations of the instructions in the modules, for example, 202a, 202c, 203a, 203c, 205a, 205c, 205d, 901a, etc. The program counter stores a number that identifies the current position in the program of the virtual machine shim 202a or 203a and the hypervisor shim 205a.

The instructions fetched by the processor 1301 from the program memory after being processed are decoded. The instructions are placed in an instruction register (IR) in the processor 1301. After processing and decoding, the processor 1301 executes the instructions. For example, the secure communication server module 901a of the credential authority server 901 defines instructions for receiving and responding to requests for environment credentials from the virtual machines 202 and 203 and the hypervisors 205 over secured network connections. The secure communication client 202c or 203c on the virtual machine 202 or 203 defines instructions for transmitting requests for environment credentials to the credential authority server 901. The secure communication client 202c or 203c on the virtual machine 202 or 203 also defines instructions for communicating the environment credentials to the hypervisor shims 205a associated with the hypervisors 205 via the virtual machine shim 202a or 203a for validation. The secure communication client 205c on the hypervisor 205 defines instructions for transmitting requests for environment credentials to the credential authority server 901. The validation module 205d of the hypervisor shim 205a defines instructions for receiving the communicated environment credentials and validating the communicated environment credentials to allow instantiation of the virtual machines 202 and 203 in the virtual environment 201. The defined instructions are stored in the program memory or received from a remote server.

The processor 1301 of the credential authority server 901 retrieves the instructions defined by the secure communication server module 901a and executes the instructions. The processor 1301 of the virtual machines 202 and 203 and the hypervisors 205 retrieves instructions defined by the secure communication clients 202c, 203c, and 205c and the validation module 205d, and executes the instructions. At the time of execution, the instructions stored in the instruction register are examined to determine the operations to be performed. The processor 1301 then performs the specified operations, for example, arithmetic and logic operations. The operating system performs multiple routines for performing a number of tasks required to assign the input devices 1307, output devices 1310, and the memory unit 1302 for execution of the virtual machine shim 202a or 203a and the hypervisor shim 205a. The tasks performed by the operating system comprise assigning memory to the virtual machine shim 202a or 203a, the hypervisor shim 205a and data, moving data between the memory unit 1302 and disk units and handling input/output operations. The operating system performs the tasks on request by the operations and after performing the tasks, the operating system transfers the execution control back to the processor 1301. The processor 1301 continues the execution to obtain one or more outputs. The outputs of the execution of the virtual machine shim 202a or 203a and the hypervisor shim 205a may be displayed to the user on the display unit 1306. In an embodiment, the virtual machine shim 202a or 203a and the hypervisor shim 205a execute in the background as daemons, rather than under the control of the user.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 1301, except for a transitory, propagating signal. The computer executable instructions embodied on the non-transitory computer readable storage medium are executed by the processor 1301. The computer executable instructions which when executed by the processor 1301 cause the processor 1301 to perform the method steps for securing a virtual environment 201 and virtual machines 202 and 203 in the virtual environment 201.

The computer program product disclosed herein comprises multiple computer program codes for securing the virtual environment 201 and the virtual machines 202 and 203 in the virtual environment 201. For example, the computer program product disclosed herein comprises a first computer program code for providing a credential authority server 901 for managing environment credentials of the virtual environment 201, a second computer program code for associating a virtual machine shim 202a or 203a with each of the virtual machines 202 or 203 and for associating one or more hypervisor shims 205a with one or more hypervisors 205, a third computer program code for providing, on request, environment credentials to each of the virtual machines 202 and 203 and the hypervisors 205 on authorization of each of the virtual machines 202 and 203 and the hypervisors 205, a fourth computer program code for communicating the environment credentials provided to each of the virtual machines 202 or 203 by each virtual machine shim 202a or 203a to one or more hypervisor shims 205a, and a fifth computer program code for validating each of the virtual machines 202 or 203 associated with each virtual machine shim 202a or 203a by the hypervisors 205 associated with the hypervisor shims 205a based on the communicated environment credentials to allow instantiation of each of the virtual machines 202 or 203 in the virtual environment 201.

The computer program codes comprising the computer executable instructions for securing the virtual environment 201 and the virtual machines 202 and 203 in the virtual environment 201 are embodied on the non-transitory computer readable storage medium. The processor 1301 of the computer system 1300 retrieves these computer executable instructions and executes them for securing the virtual environment 201 and the virtual machines 202 and 203 in the virtual environment 201.

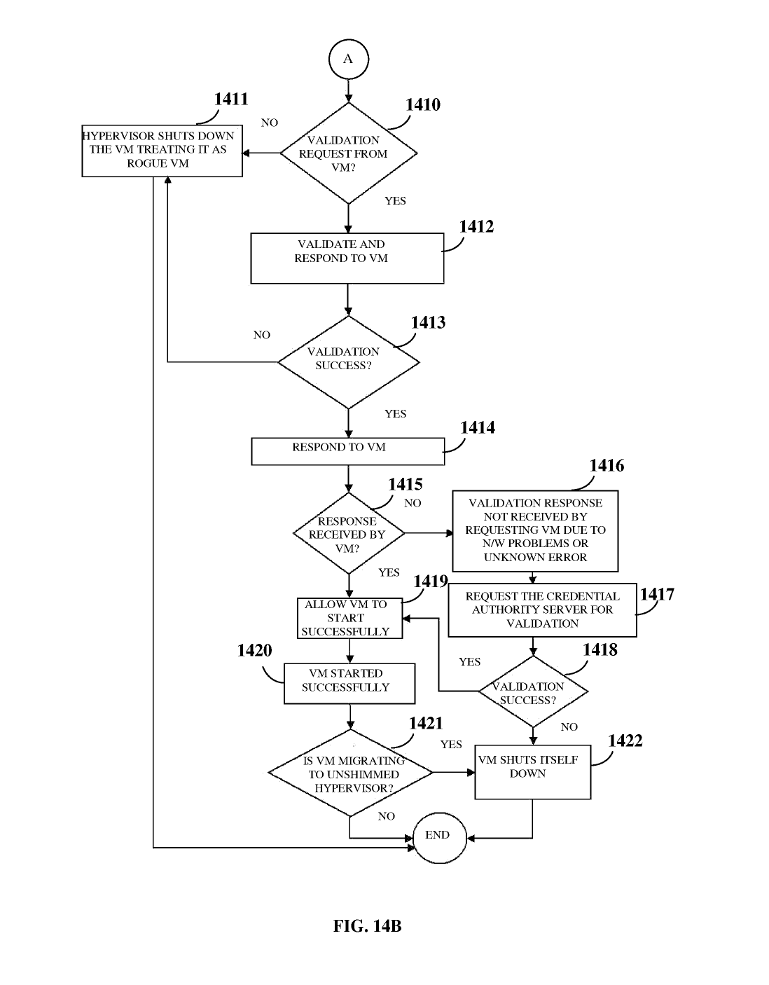

FIGS. 14A-14B exemplarily illustrate a flowchart comprising the steps of securing a virtual environment 201, for example, a virtual data center environment, and virtual machines 202 and 203 in the virtual environment 201. The existing and new virtual machines (VMs) 202 and 203 and the hypervisors 205 of the virtual environment 201 are installed 1401 with virtual machine shims 202a and 203a and hypervisor shims 205a respectively. Subsequently, when a hypervisor 205 and/or a virtual machine 202 or 203 boots up within the virtual environment 201, the hypervisor 205 and/or the virtual machine 202 or 203 respectively check 1402 for the availability of environment credentials in their respective data stores 205b, 202b, and 203b. If the environment credentials in the data stores 202b or 203b and 205b of the virtual machine 202 or 203 and the hypervisor 205 respectively are unavailable, expired or corrupted and therefore invalid 1403, the virtual machine 202 or 203 and the hypervisor 205 request 1404 for environment credentials from the credential authority server 901. The new or updated environment credentials provided by the credential authority server 901 is placed 1405 in the data stores 202b, 203b and 205b of the virtual machine 202 or 203 and the hypervisor 205, respectively. If the environment credentials are available and valid 1403, that is, if the environment credentials are not expired or corrupted, the hypervisor 205 continues to monitor 1406 for new virtual machine launches and existing virtual machine validation requests, while the virtual machine 202 or 203 is ready 1406 to send validation requests to the hypervisor 205 for instantiation.

While monitoring for validation requests, the hypervisor 205 expects to receive validation requests before a new virtual machine 202 or 203 is launched 1407 or when an existing virtual machine 202 or 203 is re-launched 1408. In either case, the hypervisor 205 waits 1409 for a validation request from the virtual machine 202 or 203. If the hypervisor 205 does not receive a validation request 1410 from the virtual machine 202 or 203 within a preconfigured period of time from instantiation or boot-up of the virtual machine 202 or 203, the hypervisor 205 shuts down 1411 the virtual machine 202 or 203 and treats the virtual machine 202 or 203 as a rogue virtual machine. If the hypervisor 205 receives a validation request 1410 from the virtual machine 202 or 203 within the preconfigured period of time from instantiation or boot-up of the virtual machine 202 or 203, the hypervisor 205 validates 1412 the virtual machine 202 or 203 using the environment credentials communicated with the validation requests and responds 1412 to the virtual machine 202 or 203 regarding the success or failure of the validation based on the communicated environment credentials. If the validation of the virtual machine 202 or 203 fails 1413, the hypervisor 205 shuts down 1411 the virtual machine 202 or 203 and treats the virtual machine 202 or 203 as a rogue virtual machine. If the validation of the virtual machine 202 or 203 is successful 1413, the hypervisor 205 responds 1414 to the virtual machine 202 or 203 granting permission to instantiate within the virtual environment 201. The virtual machine 202 or 203 receives 1415 the response and is allowed 1419 to start or launch successfully. The virtual machine 202 or 203 then starts 1420 successfully.

In instances where the virtual machine 202 or 203 does not receive 1416 the validation response from the hypervisor 205 due to network (n/w) problems or other unknown errors, the credential authority server 901 is requested 1417 to validate the virtual machine 202 or 203 as a fallback technique. If the credential authority server 901 is able to successfully validate 1418 the virtual machine 202 or 203 based on the communicated environment credentials, the virtual machine 202 or 203 is allowed 1419 to start or launch successfully. If the credential authority server 901 fails to validate 1418 the virtual machine 202 or 203 based on the communicated environment credentials, the virtual machine 202 or 203 receives a negative response from the credential authority server 901 and the virtual machine 202 or 203 shuts itself down 1422 voluntarily. Also, when a running virtual machine 202 or 203 is migrated 1421 to an unshimmed hypervisor or an uncertified environment, the virtual machine 202 or 203 shuts itself down 1422 voluntarily.

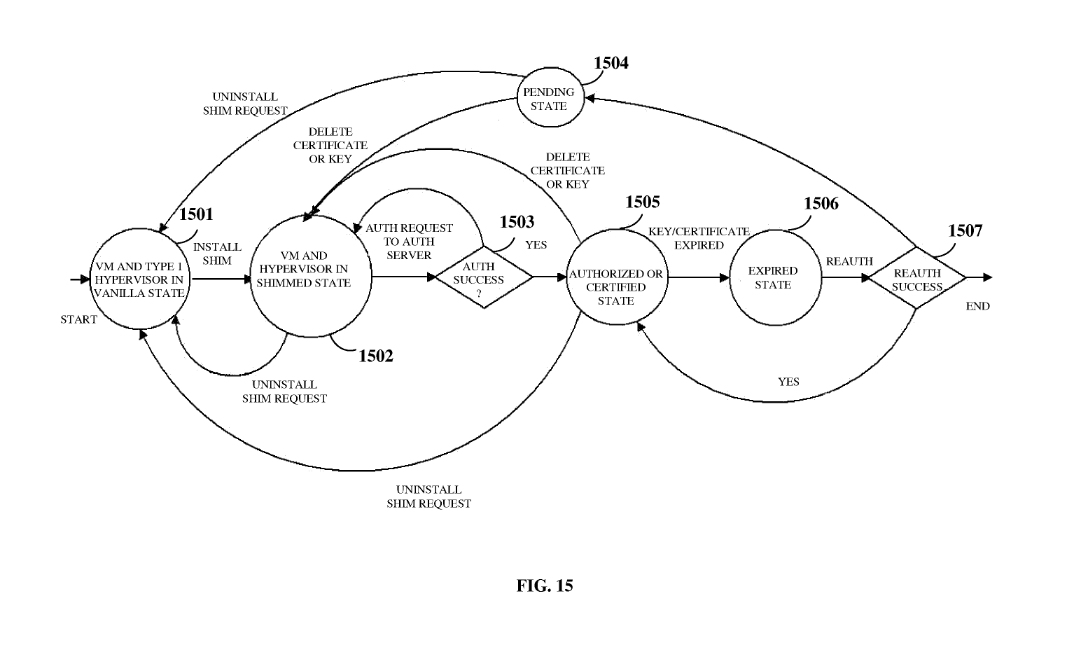

FIG. 15 exemplarily illustrates a state diagram of the computer implemented method for securing a virtual environment 201 and virtual machines 202 or 203 in the virtual environment 201. FIG. 15 illustrates the transition of the virtual machine 202 or 203 and the hypervisor 205 between a vanilla state 1501, a shimmed state 1502, an authorized or certified state 1505, and an expired state 1506. As used herein, a hypervisor 205 is said to be in the vanilla state 1501 if the hypervisor 205 has never been installed with the hypervisor shim 205a and has never contacted the credential authority server 901. As used herein, a virtual machine 202 or 203 is said to be in the vanilla state 1501 if the virtual machine 202 or 203 has never contacted the credential authority server 901 and/or the virtual machine shim 202a or 203b is not installed on the virtual machine 202 or 203. Referring to FIG. 15, the virtual machine 202 or 203 and the hypervisor 205 are in the vanilla state 1501 until their respective shims 202a or 203b and 205a are installed. The virtual machine 202 or 203 and the hypervisor 205 move to a shimmed state 1502 after the installation of the shim software or client of their shims 202a or 203b and 205a respectively. Subsequently, the virtual machine 202 or 203 and the hypervisor 205 attempt for authorization with the credential authority (auth) server 901. On successful authorization 1503, the virtual machine 202 or 203 and the hypervisor 205 move to an authorized or certified state 1505. The virtual machine 202 or 203 and the hypervisor 205 remain in the shimmed state 1502 until they are successfully authorized and move to the authorized or certified state 1505. From thereon, the virtual machine 202 or 203 and the hypervisor 205 can move to an expired state 1506 when the environment credential, for example, a security key or a digital certificate expires or move back to the shimmed state 1502 after deletion of the environment credentials. In the expired state 1506, the virtual machine 202 or 203 and the hypervisor 205 can reauthorize themselves with the credential authority server 901 by renewing the environment credentials. On successful reauthorization 1507, the virtual machine 202 or 203 and the hypervisor 205 revert to the authorized or certified state 1505. The virtual machine 202 or 203 and the hypervisor 205 may otherwise enter an idle pending state 1504 waiting for transition to either the shimmed state 1502 or the vanilla state 1501. The virtual machine 202 or 203 and the hypervisor 205 transition from the pending state 1504 to the shimmed state 1502, if the virtual machine 202 or 203 and the hypervisor 205 delete their respective environment credentials. When the virtual machine 202 or 203 and the hypervisor 205 are in the pending state 1504, the shimmed state 1502 or the authorized or certified state 1505, if the virtual machine 202 or 203 and the hypervisor 205 request to uninstall their respective shims 202a or 203a and 205a, the virtual machine 202 or 203 and the hypervisor 205 revert back to the vanilla state 1501.

In an embodiment, the computer implemented system 900 disclosed herein is configured using a software package, herein referred to as SecureVM package comprising server software for the credential authority server 901 and client software for installing the hypervisor shim 205a and the virtual machine shim 202a or 203a on the hypervisor 205 and the virtual machine 202 or 203, respectively. The SecureVM package is compatible to work with industry-leading hypervisors 205 and virtual machines 202 and 203 hosting a variety of operating system (OS) flavors, for example, a Unix-based operating system, a Linux-based operating system, a Windows® operating system, etc. In an embodiment, the SecureVM package can be configured or modified to support different hypervisors other than the market-leading hypervisors. Furthermore, the SecureVM package can be configured to support different flavors of operating systems inside the virtual machine 202 or 203, other than the widely used Unix OS, Linux OS, and the Windows® OS. Also, during the configuration of private local area networks (LANs) or virtual local area network (VLAN) based virtual environments, the credential authority server 901 is made available through the virtual machine shims 202a and 203a and the hypervisor shims 205a of the virtual environment 201, without causing any authentication issues during the configuration of the private LANs or VLAN environments.

Although the computer implemented method and system 900 disclosed herein and its embodiments have been described with reference to credential exchange, for example, certificate exchange for authorizing and validating the hypervisors 205 and the virtual machines 202 and 203 in a virtual environment 201, the scope of the computer implemented method and system 900 disclosed herein is not limited to certificate based authentication. The computer implemented method and system 900 disclosed herein may be extended to include other authentication technologies or forms of authentication, for example, protected memory area, encoding techniques, two factor authentication (TFA), etc. For example, in the two-factor authentication technique, the virtual machines 202 and 203 may authenticate themselves using two independent authentication methods, for example, a password and an internet protocol (IP) address to increase the assurance that the virtual machines 202 and 203 are authorized to run on the hypervisor 205 within the virtual environment 201.

Consider an example, where a virtual data center runs a virtual server, for example, the VMware ESX of VMware Inc., without the backing of any other security product or trusted computing platform. The SecureVM package comprising the credential authority server 901 software and the hypervisor shim 205a and the virtual machine shim 202a or 203a software is installed on the virtual data center. The centralized credential authority server 901 is installed locally in the virtual data center and executes as a virtual machine or as a standalone machine. The environment credentials are generated and stored in the data store 901b of the credential authority server 901. The credential authority server 901 is ready to accept environment credential requests from the virtual machines 202 and 203 and the hypervisors 205 in the virtual environment 201 and respond back with the environment credentials after successful authorization of the virtual machines 202 and 203 and the hypervisors 205.

The hypervisors 205 execute on the virtual data center in the virtual environment 201. Each of the hypervisors 205 checks for the environment credentials in its respective data store 205b, and upon unavailability, requests the credential authority server 901 for the environment credentials. The credential authority server 901 provides the environment credentials to the hypervisor 205 after successful authorization. The hypervisor 205 stores the requested environment credentials in the data store 205b. The hypervisor 205 is then ready to accept environment credential validation requests from the virtual machines 202 and 203.

During boot-up, each of the virtual machines 202 and 203 identifies its own flavor, obtains the hostname of its corresponding hypervisor 205, and checks for environment credentials in its respective local data store 202b or 203b. Upon unavailability, the virtual machine 202 or 203 requests the environment credentials from the credential authority server 901 and stores the requested environment credentials in the local data store 202b or 203b. The virtual machine shim 202a or 203a associated with the virtual machine 202 or 203 then communicates the environment credentials to the hypervisor shim 205a associated with the hypervisor 205 over a secure connection for validation. On successful validation, the virtual machine 202 or 203 logs into the virtual environment 201 and on failure, the virtual machine 202 or 203 shuts down. A new virtual machine introduced into the virtual data center is treated as an unauthorized or rogue virtual machine by the hypervisor 205, if the new virtual machine fails to send a validation request along with the environment credentials to the hypervisor 205 within a preconfigured time after boot-up. The hypervisor 205 forcefully shuts down the rogue virtual machine.

Consider another example, where a virtual data center runs a virtual server, for example, the VMware ESX of VMware Inc., which is supported by a trusted hardware platform, for example, the trusted platform module (TPM). The SecureVM package comprising the credential authority server 901 software and the hypervisor shim 205a and the virtual machine shim 202a or 203a software is installed on the virtual data center. The centralized credential authority server 901 is installed locally in the virtual data center and executes as a virtual machine or is installed remotely as a standalone machine. The environment credentials are generated and stored in a TPM store of the credential authority server 901. The credential authority server 901 is ready to accept environment credential requests from the virtual machines 202 and 203 and the hypervisors 205 in the virtual environment 201 and respond back with the environment credentials after successful authorization.

The hypervisors 205 execute on the virtual data center. Each of the hypervisors 205 checks for the environment credentials in its respective TPM store, and upon unavailability, requests the credential authority server 901 for the environment credentials. The credential authority server 901 provides the environment credentials to the hypervisor 205 after successful authorization. The hypervisor 205 stores the requested environment credentials in its TPM store. The hypervisor 205 is then ready to accept environment credential validation requests from the virtual machines 202 and 203.

During boot-up, each of the virtual machines 202 and 203 identifies its own flavor, obtains the hostname of its corresponding hypervisor 205, and checks for environment credentials in its local virtual trusted platform module (vTPM) store. Upon unavailability, the virtual machine 202 or 203 requests the environment credentials from the credential authority server 901 and stores the requested environment credentials in the local vTPM store. The virtual machine shim 202a or 203a associated with the virtual machine 202 or 203 then communicates the environment credentials to the hypervisor shim 205a associated with the hypervisor 205 over a secure connection for validation. On successful validation, the virtual machine 202 or 203 logs into the virtual environment 201 and on failure, the virtual machine 202 or 203 shuts down. A new virtual machine introduced into the virtual data center is treated as an unauthorized or rogue virtual machine by the hypervisor 205, if the new virtual machine fails to send a validation request along with the environment credentials to the hypervisor 205 within a preconfigured time after its boot-up. The hypervisor 205 forcefully shuts down the rogue virtual machine.

Consider another example, where the centralized credential authority server 901 executes remotely on a web portal to provide virtualization security as a service (vSaaS) over a private or public network. The remote credential authority server 901 accepts environment credential requests from the virtual machines 202 and 203 and the hypervisors 205 of various enterprises and responds back with the enterprise-specific environment credentials after successful authorization. Each enterprise installs the SecureVM package comprising the hypervisor shim 205a and the virtual machine shims 202a and 203a on the hypervisor 205 and the virtual machines 202 and 203, respectively, of the enterprise's virtual data center(s).

The hypervisor 205 executes on the enterprise's virtual data center. The hypervisor 205 checks for the environment credentials in their respective data stores 205b or TPM stores, and upon unavailability, requests the external credential authority server 901 for the environment credentials. The credential authority server 901 provides the environment credentials to the hypervisor 205 after successful authorization. The hypervisor 205 stores the requested environment credentials in the data store 205b or a TPM store. The hypervisor 205 is then ready to accept environment credential validation requests from the virtual machines 202 and 203 within the enterprise's virtual data center.

During boot-up inside the enterprise virtual data center, each of the virtual machines 202 and 203 identifies its own flavor, obtains the hostname of its corresponding hypervisor 205, and checks for environment credentials in its respective local data store 202b or 203b or vTPM store. Upon unavailability, the virtual machine 202 or 203 requests the environment credentials from the external credential authority server 901 and stores the requested environment credentials in the local data store 202b or 203b or a vTPM store. The virtual machine shim 202a or 203a associated with the virtual machine 202 or 203 then communicates the environment credentials to the hypervisor shim 205a associated with the hypervisor 205 over a secure connection for validation. On successful validation, the virtual machine 202 or 203 logs into the virtual environment 201 and on failure, the virtual machine 202 or 203 shuts down. A new virtual machine introduced into the enterprise's virtual data center is treated as an unauthorized or rogue virtual machine by the hypervisor 205, if the new virtual machine fails to send a validation request along with the environment credentials to the hypervisor 205 within a preconfigured time after boot-up. The hypervisor 205 forcefully shuts down the rogue virtual machine.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

Where databases are described such as the data stores 202b, 203b, 204b, 205b, 901b, 1101, and 1201b, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes, such as those disclosed herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method for securing a virtual environment and virtual machines in said virtual environment, comprising:
providing a credential authority server for managing environment credentials of said virtual environment;
associating a virtual machine shim with each of said virtual machines and associating one or more hypervisor shims with one or more hypervisors, wherein each of said one or more hypervisors is configured to host and monitor one or more of said virtual machines in said virtual environment;
providing, on request, environment credentials to each of said virtual machines and said one or more hypervisors by said credential authority server on authorization of said each of said virtual machines and said one or more hypervisors by said credential authority server;
communicating said environment credentials provided to said each of said virtual machines, by each said virtual machine shim to said one or more hypervisor shims; and
validating said each of said virtual machines associated with each said virtual machine shim by said one or more hypervisors associated with said one or more hypervisor shims based on said communicated environment credentials to allow instantiation of said each of said virtual machines in said virtual environment.

2. The computer implemented method of claim 1, wherein providing said environment credentials to said each of said virtual machines and said one or more hypervisors, comprises:
receiving requests for said environment credentials from said each of said virtual machines and said one or more hypervisors by said credential authority server upon unavailability of pre-stored environment credentials in said each of said virtual machines and said one or more hypervisors respectively, wherein said credential authority server receives said requests from said each of said virtual machines and said one or more hypervisors periodically and during boot-up of said each of said virtual machines and said one or more hypervisors; and
providing said environment credentials to said each of said virtual machines and said one or more hypervisors on said authorization of said each of said virtual machines and said one or more hypervisors by said credential authority server based on one or more authorization parameters associated with said requests.

3. The computer implemented method of claim 2, wherein said one or more authorization parameters comprise a single internet protocol address associated with said requests, a range of internet protocol addresses associated with said requests, a subnet associated with said requests, a media access control address, a domain name, a hostname, and any other unique identifier.

4. The computer implemented method of claim 1, further comprising restricting said instantiation of said virtual machines by said one or more hypervisors if said one or more hypervisors fail to validate said each of said virtual machines based on said communicated environment credentials.

5. The computer implemented method of claim 1, further comprising forcefully terminating an unauthorized virtual machine from said virtual machines by said one or more hypervisors, if said virtual machine shim associated with said unauthorized virtual machine fails to communicate said environment credentials to said one or more hypervisor shims for said validation within a preconfigured period of time from instantiation of said unauthorized virtual machine.

6. The computer implemented method of claim 1, wherein said environment credentials comprise a digital certificate, a security key, and a security name and password, wherein said validation of said each of said virtual machines by said one or more hypervisors to instantiate said each of said virtual machines is based on validation of said digital certificate, said security key, and said security name and said password by said one or more hypervisor shims.

7. The computer implemented method of claim 1, wherein said credential authority server manages said environment credentials of said virtual environment locally within said virtual environment.

8. The computer implemented method of claim 1, wherein said credential authority server manages said environment credentials of said virtual environment remotely as a virtualization security service over a public network.

9. The computer implemented method of claim 1, wherein each of said one or more hypervisors is one of a native hypervisor and a hosted hypervisor, wherein said environment credentials certify said native hypervisor when said one or more hypervisors is said native hypervisor, and wherein said environment credentials certify a host operating system hosting said one or more hypervisors when said one or more hypervisors is said hosted hypervisor.

10. The computer implemented method of claim 1, further comprising storing said environment credentials in a secure data store within each of said virtual machines and said one or more hypervisors.

11. The computer implemented method of claim 1, wherein said one or more hypervisor shims manage said instantiation of said virtual machines locally from within said hypervisors in said virtual environment.

12. The computer implemented method of claim 1, wherein said one or more hypervisor shims manage said instantiation of said virtual machines on a management virtual appliance that hosts said one or more hypervisor shims in said virtual environment.

13. The computer implemented method of claim 1, further comprising:
reinstantiating one or more of said validated virtual machines in said virtual environment;
verifying whether said virtual environment is certified by each said virtual machine shim associated with each of said reinstantiated one or more virtual machines; and
terminating said reinstantiated one or more virtual machines by each said virtual machine shim if said virtual environment is uncertified.

14. The computer implemented method of claim 1, further comprising:
migrating one or more of said validated virtual machines from one of said one or more hypervisors to another one of said one or more hypervisors across said virtual environment;
verifying whether said virtual environment is certified by each said virtual machine shim associated with each of said migrated one or more virtual machines; and
terminating said migrated one or more virtual machines by each said virtual machine shim if said virtual environment is uncertified.

15. The computer implemented method of claim 1, further comprising:
migrating one or more virtual machines from a first certified hypervisor among said one or more hypervisors to a second certified hypervisor among said one or more hypervisors across said virtual environment; and
restricting instantiation of said migrated one or more virtual machines by said second certified hypervisor if said second certified hypervisor fails to validate said communicated environment credentials of said migrated one or more virtual machines.

16. The computer implemented method of claim 1, further comprising:
migrating one or more virtual machines from one of said one or more hypervisors to another one of said one or more hypervisors across said virtual environment;
verifying whether a host operating system hosting said another one of said one or more hypervisors is certified by each said virtual machine shim associated with each of said migrated one or more virtual machines; and
terminating said migrated one or more virtual machines by each said virtual machine shim if said host operating system is uncertified.

17. The computer implemented method of claim 1, further comprising:
migrating one or more virtual machines from a first host operating system hosting a first certified hypervisor among said one or more hypervisors to a second host operating system hosting a second certified hypervisor among said one or more hypervisors across said virtual environment; and
restricting instantiation of said migrated one or more virtual machines by said second host operating system hosting said second certified hypervisor if said second host operating system fails to validate said communicated environment credentials of said migrated one or more virtual machines.

18. The computer implemented method of claim 1, wherein each said virtual machine shim and said one or more hypervisor shims periodically contact said credential authority server at predetermined intervals of time for renewing said environment credentials stored in said each of said virtual machines and said one or more hypervisors.

19. The computer implemented method of claim 1, further comprising:
detecting duplication of one or more of said virtual machines in said virtual environment; and
restricting instantiation of said duplicated one or more virtual machines by said one or more hypervisors when each said virtual machine shim associated with each of said duplicated one or more virtual machines fails to send requests for said environment credentials from said duplicated one or more virtual machines to said credential authority server and/or fails to communicate said environment credentials to said one or more hypervisor shims for said validation.

20. A computer implemented system for securing a virtual environment and virtual machines in said virtual environment, comprising:
a credential authority server that manages environment credentials of said virtual environment, said credential authority server comprising a secure communication server module that receives and responds to requests for said environment credentials from said virtual machines and one or more hypervisors on authorization of each of said virtual machines and said one or more hypervisors, over secured network connections;
a virtual machine shim associated with each of said virtual machines, each of said virtual machines comprising a secure communication client that transmits said requests for said environment credentials to said credential authority server and communicates said environment credentials to one or more hypervisor shims associated with said one or more hypervisors via said virtual machine shim for validation; and
said one or more hypervisor shims associated with said one or more hypervisors, wherein each of said one or more hypervisors is configured to host and monitor one or more of said virtual machines in said virtual environment and to validate said virtual machines based on said communicated environment credentials, wherein said each of said one or more hypervisors comprises:
a secure communication client that transmits said requests for said environment credentials to said credential authority server; and
a validation module within each of said one or more hypervisor shims, wherein said validation module receives and validates said communicated environment credentials and enables said one or more hypervisors to validate said each of said virtual machines associated with each said virtual machine shim based on the communicated environment credentials to allow instantiation of said each of said virtual machines in said virtual environment.

21. The computer implemented system of claim 20, wherein said each of said virtual machines and each of said one or more hypervisors comprises a secure data store that stores said environment credentials provided by said credential authority server.

22. The computer implemented system of claim 20, wherein said credential authority server provides said environment credentials to said each of said virtual machines and said one or more hypervisors on said authorization of said each of said virtual machines and said one or more hypervisors based on one or more authorization parameters associated with said requests, wherein said one or more authorization parameters comprise a single internet protocol address associated with said requests, a range of internet protocol addresses associated with said requests, a subnet associated with said requests, a media access control address, a domain name, a hostname, and any other unique identifier, and wherein said credential authority server receives said requests from said each of said virtual machines and said one or more hypervisors periodically and during boot-up of said each of said virtual machines and said one or more hypervisors.

23. The computer implemented system of claim 20, wherein said one or more hypervisors restrict said instantiation of said virtual machines if said one or more hypervisors fail to validate said each of said virtual machines based on said communicated environment credentials.

24. The computer implemented system of claim 20, wherein said one or more hypervisors forcefully terminate an unauthorized virtual machine from said virtual machines, if said virtual machine shim associated with said unauthorized virtual machine fails to communicate said environment credentials to said one or more hypervisor shims for said validation within a preconfigured period of time from instantiation of said unauthorized virtual machine.

25. The computer implemented system of claim 20, wherein said one or more hypervisors validate said each of said virtual machines to instantiate said each of said virtual machines based on validation of said environment credentials comprising a digital certificate, a security key, and a security name and password by said one or more hypervisor shims.

26. The computer implemented system of claim 20, wherein said credential authority server manages said environment credentials of said virtual environment locally within said virtual environment.

27. The computer implemented system of claim 20, wherein said credential authority server manages said environment credentials of said virtual environment remotely as a virtualization security service over a public network.

28. The computer implemented system of claim 20, wherein each of said one or more hypervisors is one of a native hypervisor and a hosted hypervisor, wherein said environment credentials certify said native hypervisor when said one or more hypervisors is said native hypervisor, and wherein said environment credentials certify a host operating system hosting said one or more hypervisors when said one or more hypervisors is said hosted hypervisor.

29. The computer implemented system of claim 20, wherein said one or more hypervisor shims manage said instantiation of said virtual machines locally from within said hypervisors in said virtual environment.

30. The computer implemented system of claim 20, wherein said one or more hypervisor shims manage said instantiation of said virtual machines on a management virtual appliance that hosts said one or more hypervisor shims in said virtual environment.

31. The computer implemented system of claim 20, wherein each said virtual machine shim and said one or more hypervisor shims periodically contact said credential authority server at predetermined intervals of time for renewing said environment credentials stored in said each of said virtual machines and said one or more hypervisors.

32. A computer program product comprising computer executable instructions embodied in a non-transitory computer readable storage medium, wherein said computer program product comprises:
a first computer program code for providing a credential authority server for managing environment credentials of a virtual environment;
a second computer program code for associating a virtual machine shim with each of a plurality of virtual machines and for associating one or more hypervisor shims with one or more hypervisors;
a third computer program code for providing, on request, environment credentials to each of said virtual machines and said one or more hypervisors on authorization of said each of said virtual machines and said one or more hypervisors;
a fourth computer program code for communicating said environment credentials provided to said each of said virtual machines, by each said virtual machine shim to said one or more hypervisor shims; and
a fifth computer program code for validating said each of said virtual machines associated with each said virtual machine shim by said one or more hypervisors associated with said one or more hypervisor shims based on said communicated environment credentials to allow instantiation of said each of said virtual machines in said virtual environment.
